(19) United States
(12) Patent Application Publication
(10) Pub. No.: US 2003/0215069 A1
(43) Pub. Date: Nov. 20, 2003

(54) Law enforcement call monitoring

(76) Inventor: Bonnie Marie Hitzeman, Winfield, IL (US)

Correspondence Address: Werner Ulrich, 434 Maple Street, Glen Ellyn, IL, 60137, US

(21) Appl. No.: 10/145,474

(22) Filed: May 14, 2002

(51) Int. Cl. H04M 1/24; H04M 3/22; H04M 1/64

(52) U.S. Cl. 379/88.19; 379/32.01

(57) ABSTRACT

A method and apparatus for selectively controlling the connection of a call to a monitoring station, as well as to a called party. Callers and called parties are required to identify themselves through the use of a Personal Identification Number (PIN), or some device such as a thumb reader. A database maintains a list of legitimate personal identification numbers, and of those personal identification numbers or thumb prints which require that a call be monitored. Advantageously, law enforcement agencies can control the monitoring of a call from or to a particular party as identified by a personal identification number or a thumb print, no matter where the call originates or terminates.

### TECHNICAL FIELD

This invention relates to a method and apparatus for selectively monitoring telephone calls.

### PROBLEM

The events of Sep. 11, 2001, have conclusively shown the importance of being able to monitor telephone conversations from or to selected individuals. Unfortunately, these selected individuals cannot always be tied to particular telephone numbers or telephone instruments. A problem of the prior art is that there is no good way to selectively monitor telephone conversations from or to selective individuals.

### SOLUTION

The above problem is solved and an advance is made over the teachings of the prior art in accordance with Applicants' invention, wherein originators and terminators of all calls except from or to a selected sub-set of telephone numbers are required to identify themselves. In accordance with Applicants' preferred embodiment, this identification consists of a personal identification number. This personal identification number is provided to an originating switch before a call is allowed to proceed, and to a terminating switch before the call is cut-through to a terminating party. The personal identification number (PIN) is checked against a list of personal identification numbers of individuals who are to be monitored, and if there is a match, the call is completed, but is also directed to a monitoring station. The database can also be used to determine whether features, such as three-way calling are assigned to the PIN, in which case monitoring of calls for that PIN is made optional. Advantageously, calls from or to a telephone user having a personal identification number that a law enforcement agency wishes to monitor, is automatically connected to a monitoring station.

In accordance with an alternative embodiment of Applicants' invention, a device such as a thumb reader is used to identify a caller or a called party, and the identification information associated with the thumb reading is the information passed to the database to determine whether the call is to be monitored.

In accordance with one feature of Applicants' invention, having created a system for identifying callers and called parties, this identification can also be used for providing features to telephone customers; especially those features which are different for different users of a particular telephone. For example, a child in a household may be assigned a different personal identification number than the parent, and the child may be denied long distance calling privileges or calling privileges to “900” numbers.

In accordance with another feature of Applicants' invention, a truncated personal identification number can be used if the user is calling from his/her home telephone. The home telephone is identified in the usual manner through automatic number identification or its equivalent for wireless systems, and the database then need only check for the presence of an abbreviated personal identification number.

Since a full personal identification number is likely to require at least 10 digits, a device which has recorded therein a personal identification number, and which can transmit such a number as a series of Dual-Tone Multi-Frequency (DTMF) tone pairs can be used to ease the burden of transmitting a PIN from the caller or the called party; for callers having speed dialing service, the PIN (or its abbreviated version).

In accordance with one feature of Applicants' invention, the database is a distributed database. A Monitoring Administrator broadcasts changes in the personal identification numbers to be monitored to the destinations of the distributed database. Each destination may have a complete database or a partial database for the PINs most commonly used in a particular region, with arrangements to query other databases if the PIN is not found locally.

In accordance with one feature of Applicants' invention, if a call is forwarded, the forwarding party provides his/her PIN at the time forwarding is initiated. The call is then monitored if either the caller or the forwarder, or the terminating party has a PIN which requires that the call be monitored.

In accordance with one feature of Applicants' invention, no PIN should be required for “911” calls.

In the above discussion, the use of a PIN is assumed. If a thumb print is found to be more desirable, or represents an alternative to the PIN, then the various remarks related to the use of the PIN apply to the thumb print.

### BRIEF DESCRIPTION OF THE DRAWING(S)

FIG. 1 is a block diagram illustrating the operation of Applicants' invention; and

FIG. 2 is a flow diagram illustrating the method of Applicants' invention.

### DETAILED DESCRIPTION

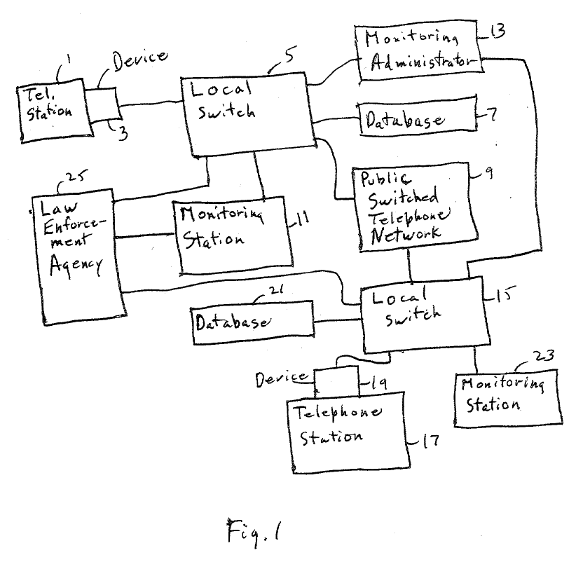

FIG. 1 is a block diagram illustrating the operation of Applicants' invention. A telephone station (1) is connected to a local switch (5). The telephone station (1) may be equipped with a device (3) for providing calling party personal identification. This device may be a unit which spews out a series of Dual-Tone Multi-Frequency (DTMF) tones representing the caller's personal identification number (PIN), or it may be thumb print reader which transmits information describing the identification characteristics of the thumb print. This information is sent to the local switch which passes it on to database (7). Database (7) checks the identification PIN to see if it is a valid PIN, and to see if the caller is on a list of telephone users whose telephone conversations are to be monitored. In the latter case, the database sends a special message, for example, a member of the CALEA message set, back to local switch (5), which causes the local switch to connect a monitoring station (11) to the call. (In alternative embodiments, the monitoring station may be placed elsewhere in the Public Switched Telephone Network (PSTN), and the local switch would signal through the Public Switched Telephone Network (PSTN) to attach a monitoring station to the call, and to identify the calling party and called party). After the local switch has received a message from the database allowing the call to go through, the local switch controls the establishment of the call in accordance with the principles of the prior art. The call is then sent to the Public Switched Telephone Network (PSTN) (9), which connects the call to a terminating local switch (15), which connects the call to telephone station (17). Telephone station (17) is equipped with device (19), similar in nature to device (3). With the possible help of device (19), telephone station (17) signals to a local switch (15) the identity of the answering party. Local switch (15) then checks in its associated database (21) to see if the call, in addition to being completed, should also be routed to a monitoring station (23) associated with local switch (15). A Law Enforcement Agency (25) is connected to the monitoring stations (11) and (23) to pick up and clear messages from these devices.

The databases are populated by information from a Monitoring Administrator (13) and/or a Law Enforcement Agency (25); the data for updating the databases is transmitted via a local switch served by a database.

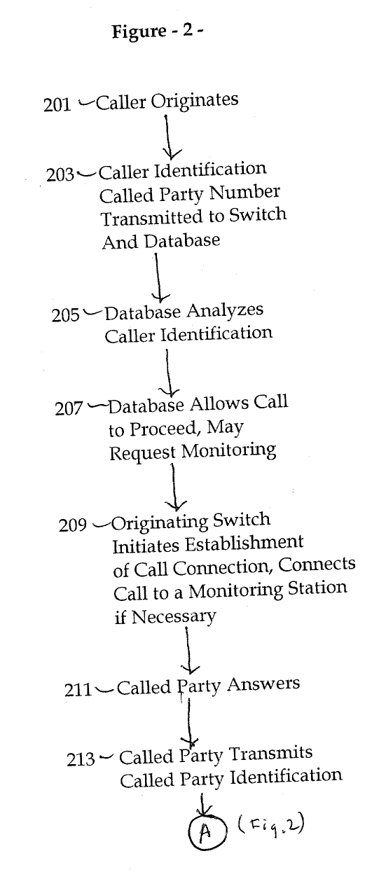

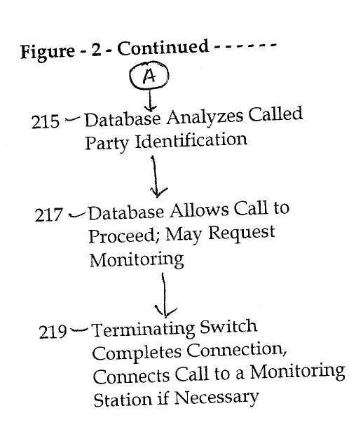

FIG. 2 is a flow diagram illustrating the operation of Applicants' invention. A caller originates a call, Action Block (201). The caller transmits its caller identification, (PIN or thumb print), and the caller party number to the connected switch and database, Action Block (203). The database analyzes the caller's identification, Action Block (205). As mentioned in the Problem Statement, the identification can be an abbreviated identification if the caller is calling from the caller's home telephone. The database then analyzes the abbreviated identification as enhanced by the caller's telephone number. The database then allows the call to proceed, but requests monitoring, Action Block (207). The originating switch then initiates establishment of the connection, and if necessary, connects the call to a monitoring station, Action Block (209). The called party is alerted, and answers the call, Action Block (211). The called party then transmits the called party identification (213) to its connected terminating switch and the associated database, Action Block (213). The database analyzes the called party identification, Action Block (215). If the database finds the identification of the called party, the database allows the call to proceed, but may request monitoring, Action Block (217). The terminating switch then completes the connection, and if necessary, connects a monitoring station, Action Block (219).

In one embodiment, calls have a voice sample taken. This voice sample can be used to identify a speaker. The identification can lead to the monitoring of the call.

The above is a description of one preferred embodiment of Applicants' invention. Other embodiments will be apparent to those of ordinary skill in the art without departing from the scope of this invention. The invention is only limited by the attached claims.

1. A method of selectively controlling the monitoring of calls from or to identified parties, comprising the steps of:
identifying the calling party of a call;
querying a database to determine whether the calling party is one whose calls are to be monitored; and
if it is determined that the calls are to be monitored, connecting a call from a party whose calls are to be monitored to a monitoring station.

2. The method of claim 1, wherein the step of identifying the calling party comprises the step of obtaining a personal identification number (PIN).

3. The method of claim 2, wherein the step of obtaining a PIN comprises the step of reading a thumb print reader output.

4. The method of claim 2, wherein the step of obtaining a PIN comprises the step of causing a series of Dual-Tone Multi-Frequency (DTMF) signals to be sent.

5. The method of claim 1, wherein the step of identifying the calling party comprises the step of analyzing a voice sample of said calling party to determine an identity of said calling party.

6. The method of claim 1, further comprising the steps of:
identifying a called party of a call;
querying a database to determine whether the called party is one whose incoming calls are to be monitored; and
it is determined that the incoming calls to the called party are to be monitored, connecting a call to the called party to a monitoring station.
